(19) United States
(12) Patent Application Publication
(10) Pub. No.: US 2018/0367587 A1
(43) Pub. Date: Dec. 20, 2018

(54) NETWORK APPLICATION DISPLAY CONTROL METHOD, AND REAL-TIME UPDATE METHOD AND APPARATUS DURING DISPLAY

(71) Applicant: Tencent Technology (Shenzhen) Company Limited, Shenzhen (CN)

(72) Inventors: Wei HUANG, Shenzhen (CN); Lifu WANG, Shenzhen (CN); Liwei HUANG, Shenzhen (CN); Shun HE, Shenzhen (CN); Xiaofang LIU, Shenzhen (CN)

(21) Appl. No.: 16/112,497

(22) Filed: Aug. 24, 2018

Related U.S. Application Data
(63) Continuation-in-part of application No. PCT/CN2017/075434, filed on Mar. 2, 2017.

(30) Foreign Application Priority Data
Mar. 2, 2016 (CN) 201610119548.7

(51) Int. Cl. H04L 29/06; A63F 13/86; A63F 13/87; G06Q 30/02

(52) U.S. Cl. CPC H04L 65/4076; A63F 13/86; G06Q 30/02; H04L 65/4053; A63F 13/87

(57) ABSTRACT

A device is configured to control display of a live broadcast of an interactive multi-user activity session in a network application. The device receives a user request for triggering an interactive live broadcast in the network application and obtains a live broadcast page for interaction in the network application from a server end. The computing device then causes display of the live broadcast page on a display located at a public broadcast location. The interaction in the network application is to be performed among users corresponding to user terminals that are located in proximity to the public broadcast location. The computing device obtains, in real time by using a persistent connection established to the server end, an update message corresponding to a dynamic change in user data in the interaction in the network application. The computing device updates display of the live broadcast page according to the update message.

### PRIORITY CLAIMS AND RELATED APPLICATIONS

This application is a continuation-in-part application of PCT application PCT/CN2017/075434, entitled “NETWORK APPLICATION DISPLAY CONTROL METHOD, AND REAL-TIME UPDATE METHOD AND APPARATUS DURING DISPLAY”, filed with the Chinese Patent Office on Mar. 2, 2017, which claims priority to Chinese Patent Application No. 201610119548.7, filed with the Chinese Patent Office on Mar. 2, 2016, and entitled “NETWORK APPLICATION DISPLAY CONTROL METHOD, AND REAL-TIME UPDATE METHOD AND APPARATUS DURING DISPLAY”, all of which are incorporated therein by reference in their entirety.

### FIELD OF THE TECHNOLOGY

The present disclosure relates to the field of computer application technologies, and in particular, to a network application display control method, and a real-time update method and apparatus during network application display.

### BACKGROUND OF THE DISCLOSURE

With the development of computer application technologies, more applications are promoted to people, to continuously meet various requirements in peoples' life and work. For new applications, most of them need to be promoted by means of a particular promotion solution, so that quantities of users using the new applications are continuously increased.

An existing promotion solution is mainly a promotion and acquisition mode in an offline scenario. Specifically, in a place with lots of people such as a mall, an application is promoted by downloading the application to get a reward or by using another simple and direct method. For example, after the application is downloaded and registration is completed, a corresponding reward can be got. In this process, acquisition for the application and rewarding can rely only on staff on site. Consequently, relatively high costs are usually caused, and a user retention rate is low.

### SUMMARY

In view of this, it is necessary to provide a network application display control method. The method can reduce promotion costs, and greatly improve a user retention rate.

In one aspect, a method is performed at a computing device (e.g., a display terminal) having one or more processors and memory. The computing device is configured to control display of a live broadcast of an interactive multi-user activity session (e.g., a multiplayer game session) in a network application (e.g., a game or app that is being promoted to the public). The computing device receives a user request for triggering an interactive live broadcast in the network application. In response to receiving the user request, the computing device obtains a live broadcast page for interaction in the network application from a server end. The computing device then causes display of the live broadcast page for interaction in the network application on a display located at a public broadcast location (e.g., on a public big-screen display at a commercial establishment, a stadium, or a public gathering location). The interaction in the network application is to be performed among users corresponding to user terminals that are located in proximity to the public broadcast location (e.g., to one another and to the public big-screen display at the public broadcast location). The computing device obtains, in real time by using a persistent connection established to the server end, an update message that is pushed by the server end according to specified content for release in the live broadcast page. The update message corresponds to a dynamic change in user data in the interaction in the network application that is performed among the users corresponding to the user terminals that are located in proximity to the public broadcast location. The computing device updates display of the live broadcast page in real time according to the update message.

According to a second aspect of the present disclosure, a computing device includes one or more processors, memory, and a plurality of instructions stored in the memory that, when executed by the one or more processors, cause the computing device to perform the aforementioned method.

According to a third aspect of the present disclosure, a non-transitory computer readable storage medium storing a plurality of instructions configured for execution by a computing device having one or more processors, the plurality of instructions causing the computing device to perform the aforementioned method.

Details of one or more embodiments of the present disclosure are provided in the following accompanying drawings and descriptions. Other features, objectives, and advantages of the present disclosure become clear in the specification, the accompanying drawings, and the claims.

In accordance with embodiments of the present disclosure, a server enables public participation of an interactive broadcast session that takes advantage of both the offline interactions between real people (e.g., hosts of a live event in a physical location) and online interactions in a software application (e.g., a game that is being promoted) to improve the teaching and understanding of the functionalities of the software application and the user's use of the software application. The efficiencies of information exchange are improved through the integration of the online and offline information exchange channels. The server utilizes the proximity of the locations of the participating users and the host to identify user who will have the benefit of offline information and interactions at the public broadcast location and facilitate online information exchange accordingly, without excessive or unnecessary information being presented to the users on the public display.

In accordance with embodiments of the present disclosure, any place such as a place with lots of people or another place may be used as an interactive live broadcast site for a network application. A display terminal is configured in the interactive live broadcast site. In the display terminal, an interactive live broadcast in the network application is triggered to obtain a live broadcast page for interaction in the network application. The live broadcast page may display, in the interactive live broadcast site, the interaction in the network application to passers-by. The interaction is performed between users corresponding to user terminals in the interactive live broadcast site. That is, the passers-by are associated by using the display terminal in the interactive live broadcast site. The current interaction in the network application is displayed by using the display terminal, and the live broadcast page is updated in real time by using a persistent connection established to a server end, so that the live broadcast page can be updated according to a dynamic user change in the interaction for specified content for release, and after any user in the interactive live broadcast site becomes a user of the network application, with interaction with another user, a depth of access by the user to the network application is increasing, thereby improving a subsequent user retention rate in the network application.

In addition, the interaction in the network application is publicly displayed by using the display terminal, and a user joining the interaction is a user corresponding to a user terminal in the interactive live broadcast site, so as to implement interaction between users nearby in the network application. In this way, the network application is rapidly promoted in the interactive live broadcast site. An entire process does not need to rely on staff on site, and promotion costs are greatly reduced.

### BRIEF DESCRIPTION OF THE DRAWINGS

FIG. 1 is a schematic structural diagram of a display terminal according to an embodiment of the present disclosure;

FIG. 2 is a flowchart of a network application display control method in a display terminal according to an embodiment of the present disclosure;

FIG. 3 is a flowchart of a method for triggering an interactive live broadcast in a network application, to obtain a live broadcast page for interaction in the network application in FIG. 2;

FIG. 4 is a flowchart of a method for updating user data on a live broadcast page in real time according to an update message in FIG. 2;

FIG. 5 is a method flowchart of a network application display control method in a user terminal according to an embodiment of the present disclosure;

FIG. 6 is a flowchart of a method for triggering, by using a live broadcast page for interaction in a network application displayed by a terminal in an interactive live broadcast site, running of the network application, and joining the interaction in the network application in FIG. 5;

FIG. 7 is a flowchart of a real-time update method during network application display according to an embodiment of the present disclosure;

FIG. 8 is a flowchart of a method for obtaining a dynamic change in user data that is in a network application and that conforms to specified content for release, and generating an update message corresponding to the dynamic change in FIG. 7;

FIG. 9 is a simplified system architectural diagram of implementing an interactive live broadcast on site in a mobile phone game application according to an embodiment of the present disclosure;

FIG. 10 is a schematic diagram of a page on which user authorization is performed in a user terminal according to an embodiment of the present disclosure;

FIG. 11 is a schematic diagram of a page for account role selection in FIG. 10;

FIG. 12 is a schematic diagram of a page that is jumped to after the account role selection in FIG. 11 is completed;

FIG. 13 is a schematic diagram of a page when a current game that is about to begin is joined in FIG. 12;

FIG. 14 is a schematic diagram of a page for making a comment in a user terminal according to an embodiment of the present disclosure;

FIG. 15 is a schematic diagram of a live broadcast page with real-time rankings of users according to an embodiment of the present disclosure;

FIG. 16 is a schematic diagram of a live broadcast page with final rankings at the end of a game according to an embodiment of the present disclosure;

FIG. 17 is a schematic diagram of a live broadcast page that is jumped to after rewarding is triggered in FIG. 16;

FIG. 18 is a schematic structural diagram of a network application display control apparatus in a display terminal according to an embodiment of the present disclosure;

FIG. 19 is a schematic structural diagram of a live broadcast triggering module in FIG. 18;

FIG. 20 is a schematic structural diagram of a real-time update module in FIG. 18;

FIG. 21 is a schematic structural diagram of a network application display control apparatus in a user terminal according to an embodiment of the present disclosure;

FIG. 22 is a schematic structural diagram of a network application running module in FIG. 21;

FIG. 23 is a schematic structural diagram of a real-time update apparatus during network application display according to an embodiment of the present disclosure; and

FIG. 24 is a schematic structural diagram of a change obtaining module in FIG. 23.

### DESCRIPTION OF EMBODIMENTS

Specific implementations of the present disclosure are described in detail in the following descriptions. It should be understood that, various changes can be made to different implementations of the present disclosure with departing from the scope of the present disclosure, and the descriptions and drawings are essentially intended to describe rather than limit the present disclosure.

As described above, in an existing offline scenario, a promotion and acquisition mode is a main solution for current application promotion, and generation of a large quantity of users in an application is driven based on the mode. Such a promotion process is essentially to implement a sharp increase in traffic in the application with rewarding. However, as time goes by, a user retention rate may fall sharply, and the application is not effectively promoted.

In view of this, to ensure effective promotion, a network application display control method is particularly provided. The network application display control method may be implemented by a computer program, and a corresponding network application display control apparatus is stored in a display terminal with a screen, so that the network application display control apparatus is run in the display terminal, to implement an interactive live broadcast in a network application in the display terminal.

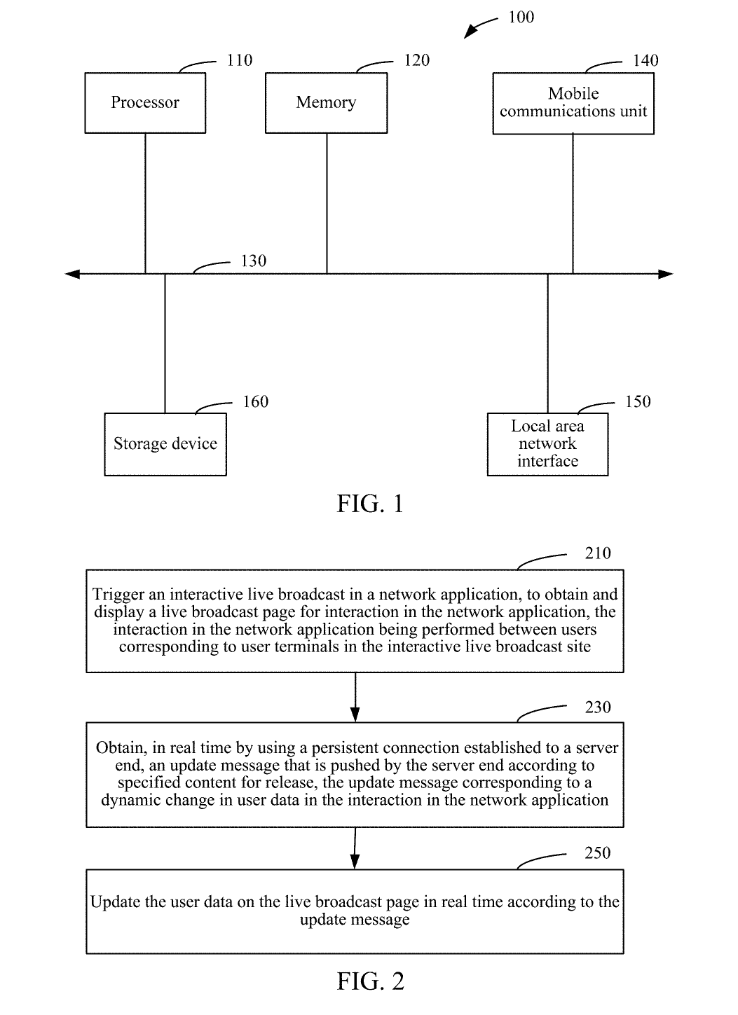

FIG. 1 shows the structure of a display terminal according to an embodiment of the present disclosure. The display terminal 100 is only an example applicable to the present disclosure, but cannot be construed as a limitation to the use scope of the present disclosure. The display terminal 100 cannot be interpreted as needing to rely on or having one or a combination of parts of the exemplary display terminal 100 shown in the figure.

As shown in FIG. 1, the display terminal 100 includes a processor 110, a memory 120, and a system bus 130. Various components including the memory 120 and the processor 110 are connected to the system bus 130. The processor 110 is hardware for executing computer program instructions by means of basic arithmetic and logic operations in a computer system. The memory 120 is a psychical device for temporarily or permanently storing a computer program or data.

The memory 120 stores corresponding program instructions. The processor 110 executes the program instructions in the memory 120, listens to various input instructions, and responds to an instruction that is obtained by means of listening.

The display terminal 100 further includes a mobile communications unit 140 and a local area network interface 150, and is configured to perform wired or wireless communication with another external device such as a server end.

The display terminal 100 further includes a storage device 160. The storage device 160 may be selected from multiple computer-readable storage mediums. A computer-readable storage medium is any available medium that can be accessed, and includes two types of storage mediums: a mobile storage medium and a fixed storage medium. For example, the computer-readable storage medium includes, but is not limited to, a flash memory (micro SD card), a CD-ROM, a digital versatile disc (DVD) or other optical disk, a cassette, a magnetic storage or another storage device, or any other mediums that can be used to store required information and can be accessed.

As described in detail above, the display terminal 100 applicable to the present disclosure performs a specified operation during network application display control, that is, performs the specified operation by running a program instruction in the memory 120 by using the processor 110, to implement network application display in the display terminal 100.

In addition, the present disclosure can also be implemented by using a hardware circuit or a combination of a hardware circuit and a software instruction. Therefore, the implementation of the present disclosure is not limited to any particular hardware circuit, software, or combination of a hardware circuit and software.

In an embodiment, specifically, a network application display control method is applied to a display terminal configured in an interactive live broadcast site. As shown in FIG. 2, the method includes the following steps:

Step 210: Trigger an interactive live broadcast in a network application, to obtain and display a live broadcast page for interaction in the network application, the interaction in the network application being performed between users corresponding to user terminals in the interactive live broadcast site.

The network application is any application in which users can interact with each other based on a network, for example, a mobile phone game application. The display terminal is a terminal device that can run the network application. In an embodiment, a large screen is configured in the display terminal, to publicly display the network application by using the configured large screen.

Access to the network application is triggered in the display terminal, to run the network application in the display terminal, and the interactive live broadcast in the run network application is triggered for the network application. The interactive live broadcast is to display, in real time, a dynamic user change in the interaction performed between the users in the network application. The dynamic user change corresponds to a dynamic change in user data in the network application. Control triggered in the user terminal causes the dynamic change in the user data.

Access information that is generated according to the network application is displayed on the live broadcast page, so that the user terminal in the interactive live broadcast site downloads or accesses the network application by using the access information, and joins the interaction in the network application.

For example, when the network application is a mobile phone game application, the interaction may be a game played in the mobile phone game application. Therefore, in the interactive live broadcast site, any user terminal can enter, by using a mobile phone game application run in the user terminal, a game that is currently broadcast live, and in the current interaction, that is, the currently played game, the user terminal may trigger various types of control.

In this case, a backend service logic responds to various types of control triggered in the user terminal. In a process of responding to control triggered in the user terminal, the user data is also updated correspondingly. For example, the user data includes values corresponding to various game indicators of the user in the game; therefore, in the interactive live broadcast in the display terminal, a real-time update is performed according to the dynamic change in the user data.

It should be noted that, the interaction may be real-time interaction, for example, a played game, or may be non-real-time interaction, for example, joining the game, grouping, or making a comment as described above.

Step 230: Obtain, in real time by using a persistent connection established to a server end, an update message that is pushed by the server end according to specified content for release, the update message corresponding to a dynamic change in user data in the interaction in the network application.

The display terminal establishes the persistent connection to the server end, to implement communication between the network application and the server end. The persistent connection is implemented by using a websocket. For example, the network application may exist in a form of a web page in a browser in the display terminal, and the persistent connection can be established to the server end by using an Html5 websocket supported by the browser. By means of the established persistent connection, the network application maintains a connection to the server end, until the network application is stopped from running, thereby ensuring that the update message in the network application is obtained in real time.

For the network application in which the interactive live broadcast is performed, on the live broadcast page that is in the network application and that is used to display the interaction in the display terminal, content is displayed according to preset content for release. The content for release is preset by the server end, and all information related to the content for release is pushed by the server end to the display terminal in real time by using an update message.

The update message carries the dynamic change in the user data that conforms to the specified content for release. In an embodiment, the specified content for release may be a user joining the interaction, a real-time ranking of the user in the interaction, or a comment made on the interaction. Therefore, the dynamic change carried in the update message is dynamic change content conforming to any one or more of the user joining the interaction, the real-time ranking of the user in the interaction, and the comment made on the interaction.

Step 250: Update the user data on the live broadcast page in real time according to the update message.

As described above, the live broadcast page displayed on the large screen of the display terminal is updated in real time according to the update message, so that on the live broadcast page, the dynamic user change in the interaction can be updated for the content for release.

Any network application can be promoted by means of the foregoing process. Any person on site is able to triggered a displayed change on the live broadcast page by using a user terminal such as a handheld portable mobile terminal of the person, thereby effectively facilitating promotion of the network application.

Because in an entire process, downloading of the network application and participation in the interaction in the network application are directly driven on site, the interaction that is broadcast live on site is implemented based on people nearby, and is deeply combined with the network application, thereby improving promotion effectiveness of the network application and a subsequent user retention rate.

The foregoing process is not limited to the promotion of the network application. On the other hand, for any network application, interaction between users of the network application can be implemented only by a network. If interaction with a user nearby needs to be implemented, a limitation of high operation costs exists, and particularly, relatively high implementation costs are required in a portable mobile terminal. However, by means of the foregoing process, users nearby can interact with each other on a same large screen, so that the interaction in the network application can be performed on line and off line, to provide a new mode for subsequent development.

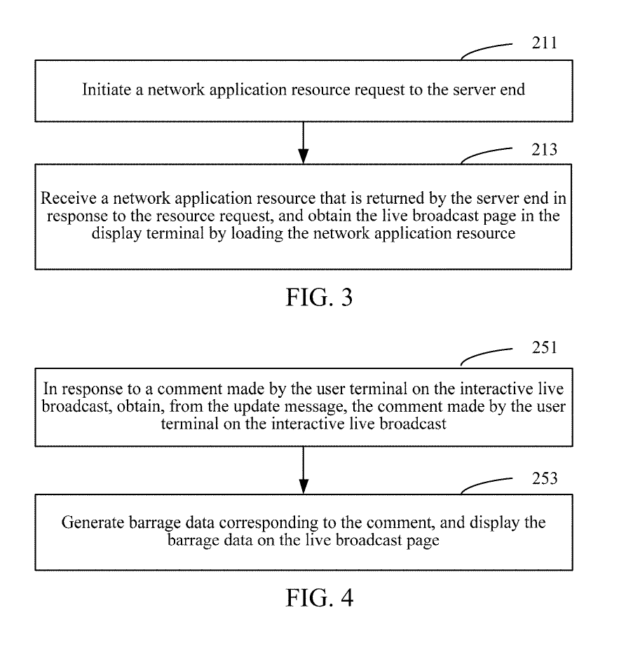

In an embodiment, as shown in FIG. 3, step 210 includes the following steps:

Step 211: Initiate a network application resource request to the server end.

When running of the network application is triggered in the display terminal, the network application resource request is initiated to the server end. The resource request includes a static resource request and a dynamic resource request.

Step 213: Receive a network application resource that is returned by the server end in response to the resource request, and obtain the live broadcast page in the display terminal by loading the network application resource.

The server end responds to the resource request initiated by the display terminal and returns the network application resource to the display terminal. The display terminal loads the network application resource, to obtain the live broadcast page in the network application on the large screen of the display terminal.

By means of the foregoing process, the display terminal starts to run the network application, and performs the interactive live broadcast, for any user terminal on site to access the network application, and even enter the current interaction in the network application.

Further, in this embodiment, the specified content for release includes an identifier of the user joining the interaction, and step 230 includes:

in response to a join request or an exit request initiated by the user terminal in the interactive live broadcast site for the live broadcast page, obtaining, in real time by using the persistent connection established to the server end, an update message that is pushed by the server end according to a change in a user quantity in the interaction.

The identifier of the user joining in the interaction is used as a piece of specified content for release, and in the interaction that is currently broadcast live, the identifier of the user entering the interaction is publicly displayed. In a process of publicly displaying the identifier of the user entering the interaction, the user currently entering the interaction may be identified by using any information such as an avatar or a nickname of the user in the network application.

That is, on the live broadcast page, the user currently joining the interaction is displayed in real time by displaying the avatar or the nickname of the user, and with a join request or an exit request triggered by the user terminal in the interactive live broadcast site, the identifier of the user is displayed on the live broadcast page is updated in real time.

For the server end, a new user may join, at any time, the interaction in the network application that is implemented on a front end. On the other hand, for multiple users that already join the interaction, a user may exit the interaction at any time, the process is accompanied with a dynamic change in the user data, and the dynamic change conforms to specified content.

Therefore, in a process in which the server end responds to the join request or the exit request by using a service logic of the network application, the server end also processes the user data, to obtain a change in the user quantity in the current interaction, and pushes the change to the display terminal in real time in a form of an update message by using the persistent connection.

In this embodiment, step 250 includes: obtaining, on the live broadcast page on which the user joining the interaction is displayed in real time, from the update message, the change in the user quantity in the interaction, and updating, in real time according to the change in the user quantity, the identifier of the user displayed on the live broadcast page.

When the display terminal displays, in real time by using the live broadcast page, the identifier of the user joining the current interaction, if the display terminal obtains the update message in real time by using the persistent connection established to the server end, the display terminal directly obtains, from the update message, the change in the user quantity in the current interaction, and updates the live broadcast page in real time accordingly.

In the display terminal, when the resource request is initiated to the server end to trigger running of the network application and broadcast live the interaction in the network application, if the interaction is not performed yet, for example, the game in the mobile phone game application is in a state of waiting to begin, during waiting to begin, any user can join the game by using access information displayed on the live broadcast page, or may exit the game that the user currently joins. In this case, an identifier of the user joining the game may be displayed on the live broadcast page in real time.

In an embodiment, the specified content for release includes a ranking of the user in the interaction, and step 250 includes:

in response to control triggered by the user terminal in the interaction, obtaining, from the update message, a real-time ranking of the user in the interaction, and updating the real-time ranking to the live broadcast page on which the interaction is displayed in real time, where the user terminal corresponds to the user joining the interaction.

During the interaction, for the currently displayed live broadcast page, the user joining the interaction triggers control by using the network application run in the user terminal of the user, to implement the interaction between the users by means of the triggered control.

The mobile phone game application is used as an example for description. The current interaction is a game. In this process, control triggered by the user terminal is control on a corresponding object in the game, for example, control on a corresponding role to move to a particular position.

The display terminal performing the interactive live broadcast updates, in real time by using the live broadcast page, control triggered by each user terminal on site. Content that is updated in real time is a current corresponding real-time ranking of the user. In this way, a state of each user in the current interaction is displayed on the interactive live broadcast site, thereby improving interactivity in the interaction.

Particularly, for the mobile phone game application, by means of the foregoing process, competitiveness and operability in the entire interaction are greatly improved, thereby improving a sense of participation of the user, and further improving the user retention rate.

In an embodiment, the specified content for release includes a comment made on the interaction, and as shown in FIG. 4, step 250 includes the following steps:

Step 251: In response to a comment made by the user terminal on the interactive live broadcast, obtain, from the update message, the comment made by the user terminal on the interactive live broadcast.

As described above, the interaction in the network application includes making a comment on the interactive live broadcast in the display terminal in the interactive live broadcast site. In the interactive live broadcast site, any user terminal can make a comment on the currently performed interactive live broadcast. The user terminal may be a user terminal currently joining the interaction, for example, a user terminal in the game in the mobile phone game application, or may be a user terminal that currently does not join the interaction.

The display terminal needs to respond to the comment made by the user terminal, and updates the comment on the live broadcast page in real time.

Specifically, when the user terminal makes a comment on the currently performed interactive live broadcast, the server end receives the comment. A comment is a piece of specified content for release. Therefore, after the server end receives a new comment, the display terminal can obtain, in real time by using the persistent connection between the display terminal and the server end, the comment that is pushed by the server end in a form of an update message.

Step 253: Generate barrage data corresponding to the comment, and display the barrage data on the live broadcast page.

A barrage display effect is preconfigured, on the live broadcast page in the display terminal, for a comment made by any user terminal. After the comment is obtained by using the update message, the corresponding barrage data is generated, to display the generated barrage data on the live broadcast page, so as to update, in a form of a barrage, a comment input by any user terminal in the interactive live broadcast site.

In an embodiment, the method further includes:

changing, in real time according to a scene switchover in the interaction, a media identifier corresponding to the live broadcast page, and switching, by using the media identifier, to a scene sound effect suitable for a scene in the interaction.

The network application run in the display terminal is implemented by using Html5, and further, during running of the network application in the display terminal, an optimal multimedia effect can be supported.

The media identifier is an audio identifier in Html5, and includes various attributes, to implement control on a media sound effect on the page.

On this basis, various scene sound effects are preset for the interactive live broadcast in the network application, to be used as alternative scene sound effects when the interactive live broadcast is performed in the network application. Further, the media identifier is changed in real time in the network application according to the scene switchover in the interaction, to switch a scene sound effect to a preset scene sound effect, so that a sound effect played in the current scene is suitable for the interactive live broadcast site, thereby further improving integration between the network application and the site, and facilitating the interaction in the network application in the interactive live broadcast site.

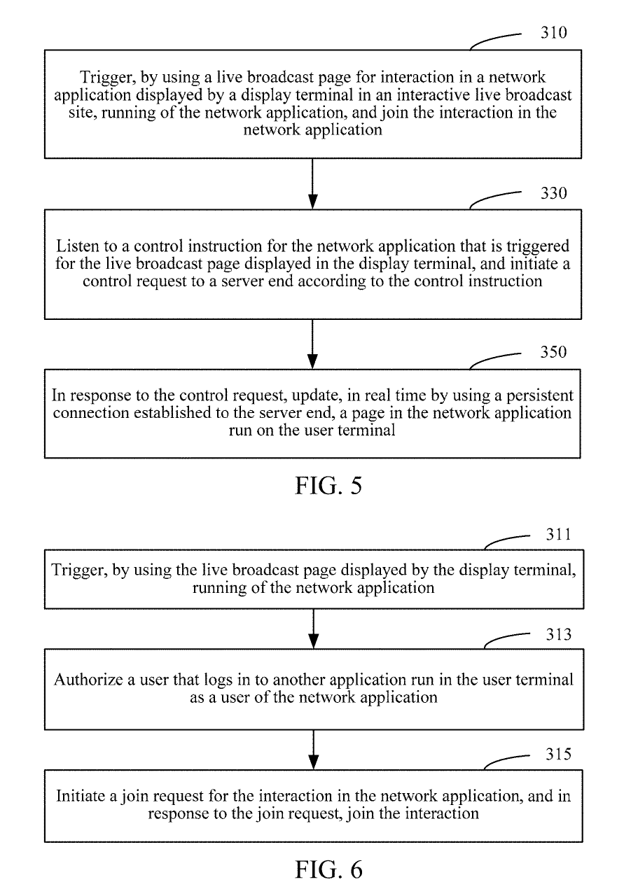

In an embodiment, a network application display control method is further provided, and is applied to a user terminal. As shown in FIG. 5, the method includes the following steps:

Step 310: Trigger, by using a live broadcast page for interaction in a network application displayed by a terminal in an interactive live broadcast site, running of the network application, and join the interaction in the network application.

As described above, an interactive live broadcast in the network application in any interactive live broadcast site is implemented by using the display terminal; and the user terminal is a control end in the interaction, and is disposed in the interactive live broadcast site. In most cases, there may be multiple user terminals.

In the interactive live broadcast site, any passer-by watches, by using the display terminal, the current interaction in the network application, for example, a game currently played in the mobile phone game application, or for another example, a comment made on a game, and during watching, may trigger, by using the live broadcast page, running of a network application in a user terminal of the passer-by, and enter the interaction that is currently broadcast live.

It should be noted that, the current interaction is identified on the live broadcast page, so that the user terminal can randomly trigger, by means of the identification on the live broadcast page, running of the network application, and joins the interaction.

In an embodiment, the current interaction is identified on the live broadcast page by displaying access information. The access information is used to trigger the user terminal to download or directly run the network application, and enter the interaction that is broadcast live.

In a preferred embodiment, the access information is a barcode graphic, for example, a two-dimensional code graphic. Any user terminal can trigger, by scanning the barcode graphic on the live broadcast page, running of the network application, and enter the interaction that is broadcast live.

Step 330: Listen to a control instruction for the network application that is triggered for the live broadcast page displayed in the display terminal, and initiate a control request to a server end according to the control instruction.

In the user terminal, the control instruction in the network application may be triggered by means of control triggered for the interaction. The control instruction may be a control instruction for a role in the game, may be a comment instruction triggered for a situation in the current interaction, or the like, and is not enumerated therein.

The control in the network application is responded to by a service logic deployed on the server end. Therefore, the network application run in the user terminal initiates the control request to the server end according to the control instruction, to wait for a response of the server end.

Step 350: In response to the control request, update, in real time by using a persistent connection established to the server end, a page in the network application run in the user terminal, and synchronously update the live broadcast page in the display terminal in real time.

On one hand, the server end responds to the control request by using the service logic deployed on the server end, and on the other hand, further processes, according to specified content for release, user data that is output according to the response, to learn of a dynamic user change related to the specified content for release.

Therefore, in response to the control request, the user terminal updates the page in the network application run in the user terminal, and the live broadcast page in the display terminal is synchronously updated in real time, to display, in real time, the dynamic user change related to the specified content for release.

By means of the foregoing process, any user terminal in the interactive live broadcast site can randomly participate in the interaction in the network application, thereby easily and rapidly implementing interaction between users nearby in the network application.

Further, in this embodiment, as shown in FIG. 6, step 310 includes the following steps:

Step 311: Trigger, by using the live broadcast page displayed in the display terminal, running of the network application in the interactive live broadcast in the network application that is triggered in the interactive live broadcast site.

That running of the network application in the user terminal is triggered means that: (1) if the network application is already installed in the user terminal, running of the network application is directly triggered; (2) if the network application is not installed in the user terminal, the network application is downloaded and installed, and running of the network application is triggered; (3) if the network application is accessed in a form of a web page in the user terminal, a browser kernel in the user terminal is loaded to access a page in the network application, to run the network application in which the interactive live broadcast is currently performed.

Step 313: Authorize a user that logs in to another application run in the user terminal as a user of the network application.

The another application may be any application that is in the user terminal and to which the user logs in, and includes an instant messaging tool, a social network application, or the like.

After running of the network application is triggered, the user that logs in to another application run in the user terminal is authorized as the user of the network application, to obtain a user identity of the user in the network application.

Any application has a corresponding account system, to uniquely identify the user. In the network application, the user that logs in to the another application is authorized, and a user account that logs into the another application is switched to a user account in the network application, to pull data in the network application, so as to smoothly run the network application in the user terminal.

In this way, the user identity in the network application can be obtained more easily, thereby facilitating improvement of promotion effectiveness of the network application, and improving a user retention rate.

Step 315: Initiate a join request for the interaction in the network application, and in response to the join request, join the interaction.

The join request for the interaction that is initiated to the server end in the network application is a join request for any interaction in the network application run in the display terminal, and is generated by means of control in the user terminal. For example, in the mobile phone game, the join request may be initiated for a game, or may be initiated for comments of users in a game. This is not limited therein.

By means of the foregoing process, the user terminal in the interactive live broadcast site can randomly run the network application, and join the interaction in the entire interactive live broadcast site. Therefore, a new method is provided for application promotion and cross-sector cooperation, to implement o2o for application promotion.

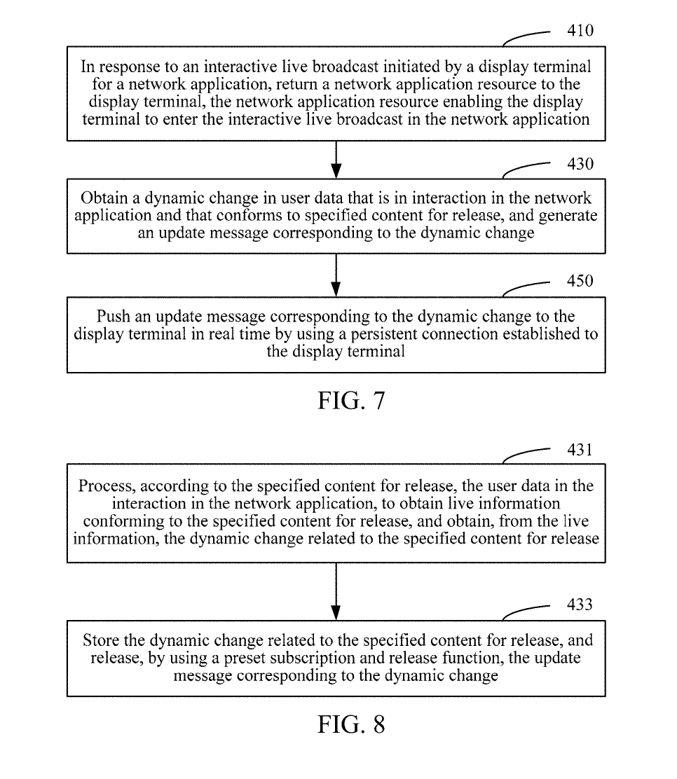

In an embodiment, a real-time update method during network application display is further correspondingly provided, and is applied to a server end. As shown in FIG. 7, the method includes the following steps:

Step 410: In response to an interactive live broadcast initiated by a display terminal for a network application, return a network application resource to the display terminal, the network application resource enabling the display terminal to enter the interactive live broadcast in the network application.

Step 430: In the interactive live broadcast, obtain a dynamic change in user data that is in interaction in the network application and that conforms to specified content for release, and generate an update message corresponding to the dynamic change.

The user data in the network application is data related to a user in the network application, and the user is a user in the interactive live broadcast site, excluding a user that is not in the interactive live broadcast site. For example, the user data may be competition results corresponding to users in a game. A server end pulls the user data in real time, to provide, in real time for the current interaction, the dynamic change in the user data that conforms to the specified content for release.

The dynamic change in the user data is obtained, and the server end processes the user data in the interaction according to the specified content for release, to obtain the dynamic change conforming to the specified content for release, and release the dynamic change in a form of a message.

Step 450: Push an update message corresponding to the dynamic change to the display terminal in real time by using a persistent connection established to the display terminal.

In this embodiment, step 450 includes: distributing the released update message to the persistent connection corresponding to the interactive live broadcast, to push the update message in real time by using the persistent connection.

During specific implementation, on the server end, a nodejs based server is deployed. The persistent connection to the display terminal is implemented by using the nodejs based server. After obtaining the update message, the nodejs based server directly distributes the update message to the corresponding persistent connection, to push the update message to the display terminal in real time.

By means of the foregoing process, the server end that can publicly display interaction performed at any place is provided for the network application, and for any network application, the interaction at any place can be publicly display only after the network application is connected to the server end, so that generality is high, and any network application can be easily promoted.

Further, as shown in FIG. 8, a specific process of step 430 includes the following steps:

Step 431: Process, in the interactive live broadcast according to the specified content for release, the user data in the interaction in the network application, to obtain live information conforming to the specified content for release, and obtain, from the live information, the dynamic change related to the specified content for release.

The live information corresponds to the specified content for release, and is related to a user joining the interaction, a real-time ranking of the user in the interaction, and a comment made on the interaction. For example, the live information may be a real-time ranking that is of the user in the current interaction and that is obtained by processing the user data.

After the live information is obtained by processing the user data, if there is a dynamic change in the live information, the dynamic change needs to be obtained, to notify the dynamic change in real time.

Step 433: Store the dynamic change related to the specified content for release, and release, by using a preset subscription and release function, the update message corresponding to the dynamic change.

In an embodiment, a Redis server stores the dynamic change and releases the update message. The obtained dynamic change is stored in the Redis server, and is released by using a subscription and release function supported by the Redis server.

In this way, when the interaction in the network application is publicly displayed, the update message is pushed in real time. Therefore, when obtaining the dynamic change, the server end can immediately and actively push the dynamic change to the display terminal.

During specific implementation, on the server end, a backend server and the Redis server are deployed. The backend server processes the user data, to obtain a dynamic change in the live information such as joining of a user in the interaction, a ranking, or a comment, and transmits the dynamic change to the Redis server for storage.

A dynamic subscription change is released by the Redis server in a form of an update message. After receiving the update message transmitted by the Redis server, the Nodejs based server directly distributes the update message to the corresponding persistent connection.

The foregoing method is described in detail below with reference to a specific embodiment. In this embodiment, a mobile phone game application is used as an example for description.

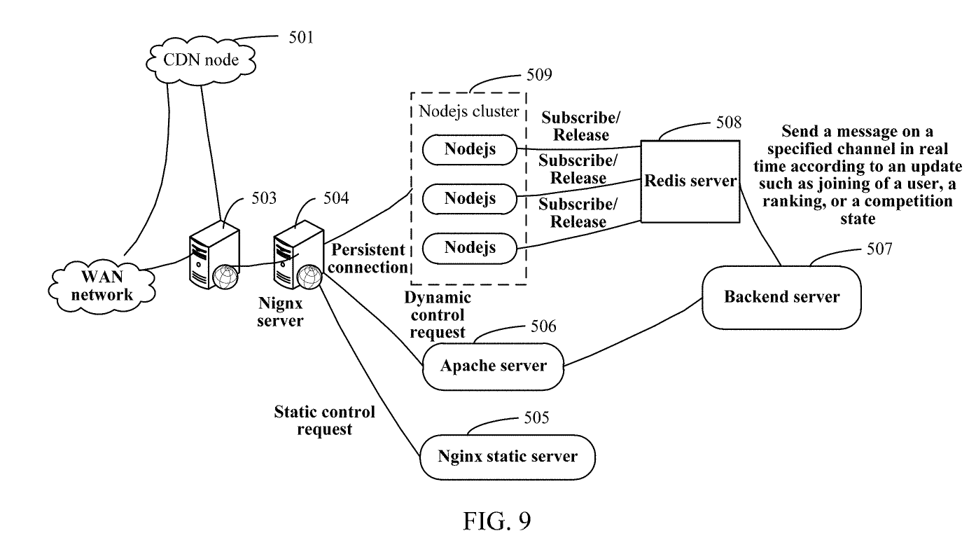

FIG. 9 is a simplified system architectural diagram of implementing an interactive live broadcast on site in a mobile phone game application according to an embodiment of the present disclosure.

It should be noted that, in this embodiment, a display terminal and a user terminal both communicate with a server end by using a wide area network (WAN).

On the server end, a CDN node 501, an access server 503, a Nignx server 504, a Nignx static server 505, an Apache server 506, a backend server 507, a Redis server 508, and a Nodejs cluster 509 are deployed.

The CDN node 501 is configured to provide a mobile phone game application resource for the display terminal and the user terminal. The access server 503 is configured to implement rapid access to a mobile phone game application in each terminal. The Nignx server 504 is used as a reverse proxy, to perform dynamic-static separation on a control request, and forward a static control request to the Nignx static server 505 with a higher concurrency value.

The Nignx server end 504 configures and forwards the control request according to a request file suffix.

A service logic is configured in the Apache server 506, to respond to the static control request.

An interactive live broadcast in the mobile phone game application on the server end is implemented by the backend server 507, the Redis server 508, and the Nodejs cluster 509.

In an interactive live broadcast site, a user joining interaction is displayed on a live broadcast page of the display terminal in real time by using an icon 601 of the user, and content displayed on the live broadcast page further includes a barcode graphic 603 for joining the interaction. The interaction may be a current game that is about to begin, or may be making a comment currently.

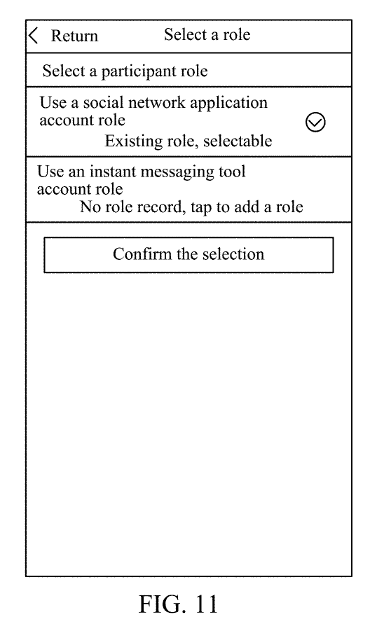

Any user terminal on site scans the barcode graphic, to run a mobile phone game application in the user terminal, and performs authorization on a page shown in FIG. 11. By means of this process, an account is not required for joining the interaction in the interactive live broadcast site, and a user can join the interaction immediately after the user scans the barcode graphic.

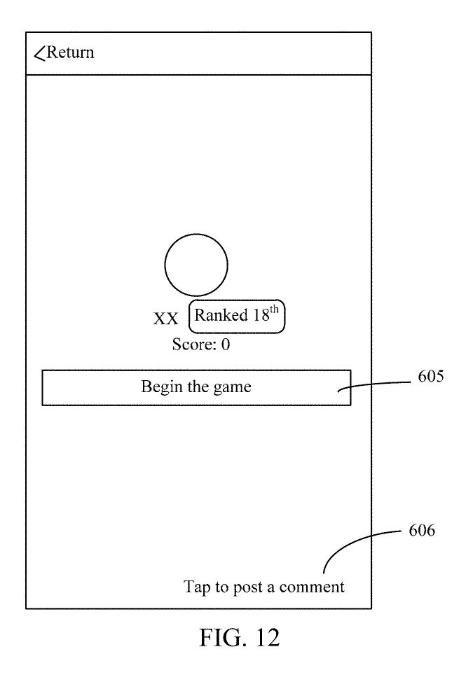

As shown in FIG. 11, an account role in an instant messaging tool may be selected, or an account role in a social network application may be selected, after the selection is completed, a page shown in FIG. 12 is jumped to. On the page, a begin button 605 may be triggered to join the game that is about to begin, or a function button 606 for posting a comment may be tapped and triggered to make a comment.

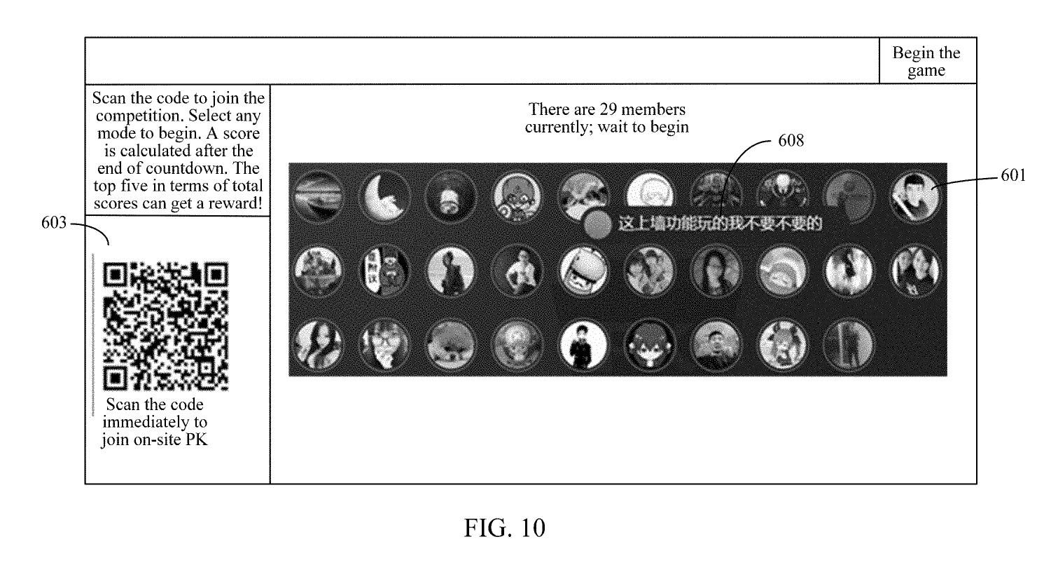

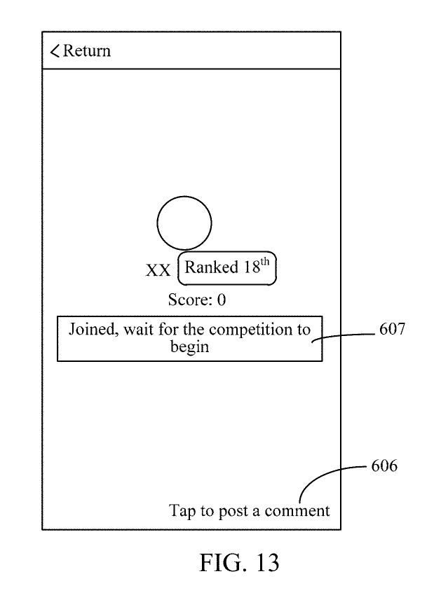

If the begin button 605 is triggered, the current game that is about to begin is joined. In this case, the user terminal jumps to a page shown in FIG. 13, and correspondingly, by means of real-time pushing by the server end, an avatar of the user is also updated to the live broadcast page shown in FIG. 10.

In addition, in both the pages shown in FIG. 12 and FIG. 13, there is a function button 606 for posting a comment, and the user may trigger the button in either one of the pages to participate in the commented interaction.

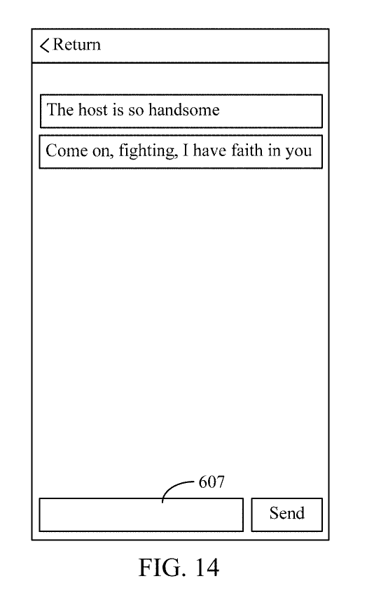

In this case, as shown in FIG. 14, content is input by using an input box 607 and is sent, to make a comment. Correspondingly, as shown in FIG. 10, the made comment is updated to the live broadcast page in real time, and is displayed by using a barrage effect, that is, barrage data 608.

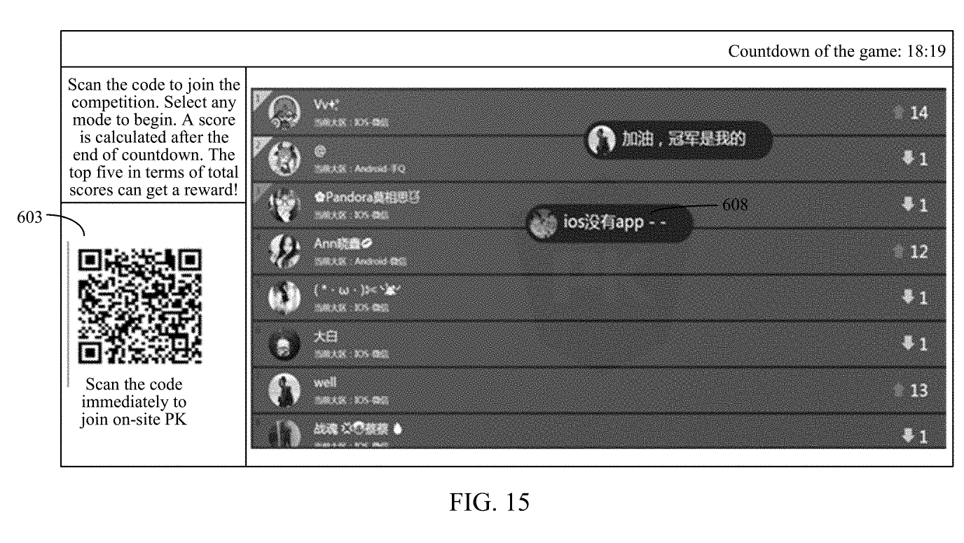

During the game, the server end calculates a real-time ranking of the user by using an end script, and updates the real-time ranking to the display terminal. The ranking of the user is updated in real time on the live broadcast page in the display terminal, that is, a live broadcast page shown in FIG. 15 is obtained.

On the live broadcast page shown in FIG. 15, real-time rankings of users on site in the currently played game and an increased or a decreased ranking of each user are shown.

At the same time, the comment made by the user is still displayed on the live broadcast page by using the barrage effect.

The server end pushes the update message in real time, and at the end of the game, the real-time ranking of the user displayed on the live broadcast page is a final ranking of the user on site in the game, as shown in FIG. 16.

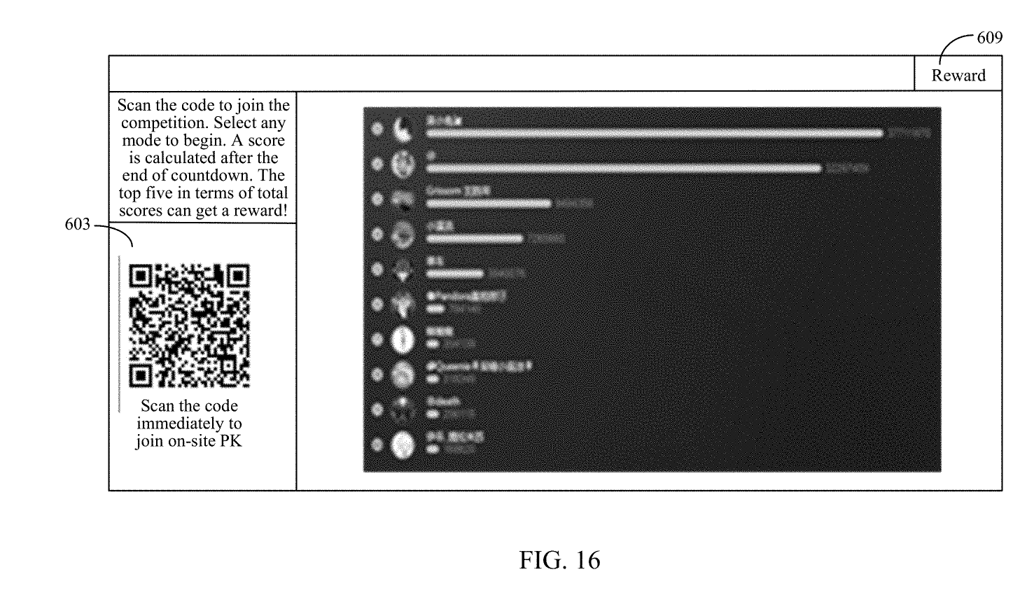

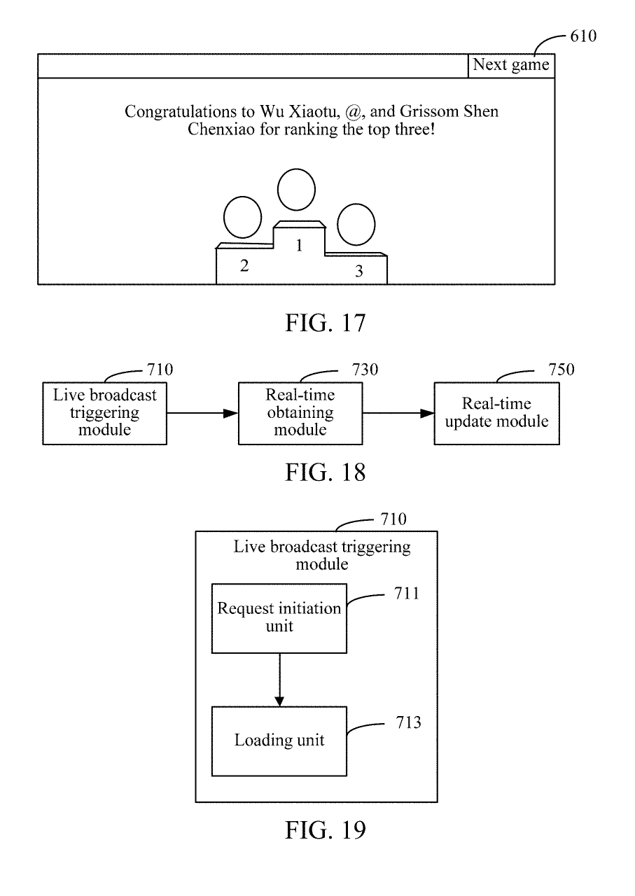

In addition, after a rewarding button 609 on a live broadcast page shown in FIG. 16 is triggered, a related live broadcast page is jumped to, as shown in FIG. 17, to perform rewarding on site for the game that is currently broadcast live, and a next game may be initiated by using a next game button 610 on the page.

By means of the foregoing process, cross-platform interaction on a same screen is implemented for the mobile phone game application, and a dynamic user change is posted in real time.

As described above, for the display terminal, when the live broadcast page is publicly displayed, a media identifier corresponding to the live broadcast page may be changed in real time to implement a sound effect and an animation suitable for the site, so as to enliven the atmosphere on site.

By means of the foregoing process, network application promotion is combined with a comment posting function, so that a user of an instant messaging tool nearby and a user of a social network application nearby can have a real-time cross-server competition, have a real-time cross-server chat, or the like on a same large screen, to provide a new mode for the interaction in the network application, so that the network application can be more easily promoted, and a subsequent user retention rate is higher.

Based on the above, in some embodiments, a method is performed at a computing device (e.g., a display terminal) having one or more processors and memory, wherein the computing device is configured to control display of a live broadcast of an interactive multi-user activity session (e.g., a multiplayer game session) in a network application (e.g., a game or app that is being promoted to the public). The computing device receives a user request for triggering an interactive live broadcast in the network application. In response to receiving the user request, the computing device obtains from a server end and causing display on a display located at a public broadcast location (e.g., on a public big-screen display at a commercial establishment, a stadium, or a public gathering location) of a live broadcast page for interaction in the network application, the interaction in the network application is to be performed among users corresponding to user terminals that are located in proximity to the public broadcast location (e.g., to one another and to the public big-screen display at the public broadcast location). The computing device obtains, in real time by using a persistent connection established to the server end, an update message that is pushed by the server end according to specified content for release in the live broadcast page, the update message corresponding to a dynamic change in user data in the interaction in the network application that is performed among the users corresponding to the user terminals that are located in proximity to the public broadcast location. The computing device updates display of the live broadcast page in real time according to the update message.

In some embodiments, the device displays, on the live broadcast page, access information (e.g., a QR code for accessing the interactive multi-user activity session) that is generated (e.g., generated locally at the computing device, or received from the server end as part of the live broadcast page) according to the network application, wherein the access information enables a user terminal to access an interactive live broadcast site to download or access the network application and to join the interaction in the network application.

In some embodiments, the step of in response to receiving the user request for triggering an interactive live broadcast in the network application, obtaining from a server end a live broadcast page for interaction in the network application, includes: initiating a network application resource request to the server end; and receiving a network application resource that is returned by the server end in response to the resource request, and obtaining the live broadcast page in the display terminal by loading the network application resource.

In some embodiments, the specified content for release in the live broadcast page comprises an identifier of a user joining the interaction, and the step of obtaining, in real time by using a persistent connection established to the server end, an update message that is pushed by the server end according to specified content for release includes: in response to a join request or an exit request initiated by a respective user terminal in the interaction in the network application (e.g., a user's request to join or exit the multi-user activity session that are received from a respective user terminal through the interactive live broadcast site or through the downloaded network application) for the live broadcast page, obtaining, in real time by using the persistent connection established to the server end, an update message that is pushed by the server end according to a change in a user count in the interaction.

In some embodiments, the step of updating the display of the live broadcast page in real time according to the update message includes: obtaining, from the update message, the change in the user quantity in the interaction, and updating, in real time according to the change in the user quantity, the identifier of the user displayed on the live broadcast page.

In some embodiments, the specified content for release comprises a ranking of the user in the interaction, and the step of updating the user data on the live broadcast page in real time according to the update message includes: obtaining, from the update message, the ranking of the users in the interaction, and updating ranking data of the users on the live broadcast page in real time.

In some embodiments, the specified content for release comprises a comment made on the interaction, and the step of updating the user data on the live broadcast page in real time according to the update message includes: obtaining, from the update message, respective comments made by one or more of the users on the interactive live broadcast; generating barrage data corresponding to the respective comments; and displaying the barrage data on the live broadcast page.

Other details of the method are described with respect to other embodiments set forth in this disclosure, and may be combined with these embodiments without limitation, and are not repeated here in the interest of brevity.

In an embodiment, a network application display control apparatus is further correspondingly provided, and is applied to a display terminal configured in an interactive live broadcast site. As shown in FIG. 18, the apparatus includes a live broadcast triggering module 710, a real-time obtaining module 730, and a real-time update module 750.

The live broadcast triggering module 710 is configured to trigger an interactive live broadcast in a network application, to obtain a live broadcast page for interaction in the network application, the interaction in the network application being performed between users corresponding to user terminals in the interactive live broadcast site.

The real-time obtaining module 730 is configured to obtain, in real time by using a persistent connection established to a server end, an update message that is pushed by the server end according to specified content for release, the update message corresponding to a dynamic change in user data in the interaction in the network application.

The real-time update module 750 is configured to update the user data on the live broadcast page in real time according to the update message.

Further, as shown in FIG. 19, in this embodiment, the live broadcast triggering module 710 includes a request initiation unit 711 and a loading unit 713.

The request initiation unit 711 is configured to initiate a network application resource request to the server end.

The loading unit 713 is configured to receive a network application resource that is returned by the server end in response to the resource request, and obtain the live broadcast page in the display terminal by loading the network application resource.

In an embodiment, the specified content for release includes an identifier of a user joining the interaction, and the real-time obtaining module 730 is further configured to: in response to a join request or an exit request initiated by the user terminal in the interactive live broadcast site for the live broadcast page, obtain, in real time by using the persistent connection established to the server end, an update message that is pushed by the server end according to a change in a user quantity in the interaction.

Further, in this embodiment, the real-time update module 750 is further configured to: obtain, on the live broadcast page on which the identifier of the user joining the interaction is displayed in real time, from the update message, the change in the user quantity in the interaction, and update, in real time according to the change in the user quantity, the identifier of the user displayed on the live broadcast page.

In an embodiment, the specified content for release includes a ranking of the user in the interaction, and the real-time update module 750 is further configured to: in response to control triggered by the user terminal in the interaction, obtain, from the update message, the ranking of the user in the interaction, and update ranking data of the user on the live broadcast page in real time.

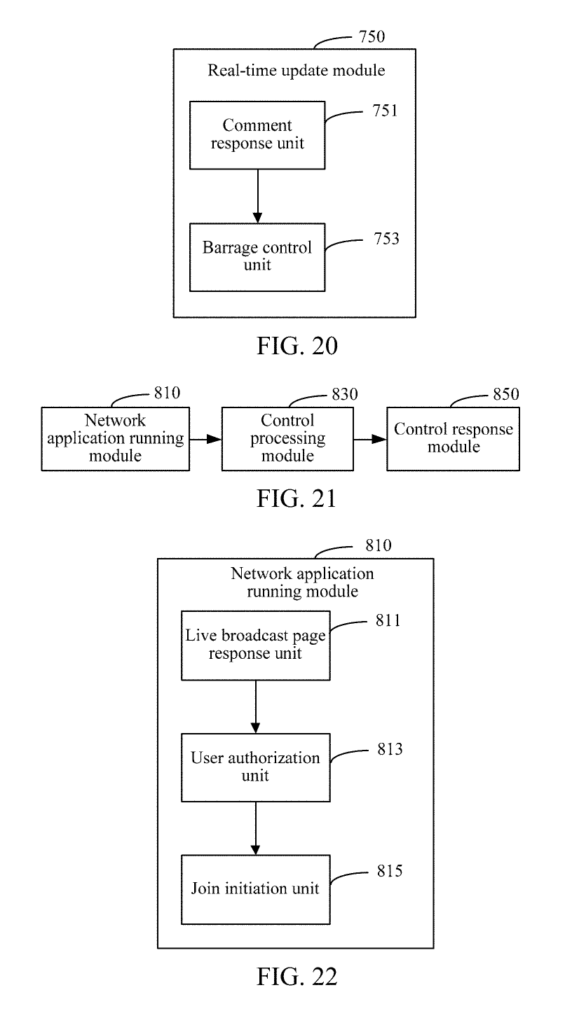

In an embodiment, the specified content for release includes a comment made on the interaction, and as shown in FIG. 20, the real-time update module 750 includes a comment response unit 751 and a barrage control unit 753.

The comment response unit 751 is configured to: in response to a comment made by any user terminal on the interactive live broadcast, obtain, from the update message, the comment made by the user terminal on the interactive live broadcast.

The barrage control unit 753 is configured to: generate barrage data corresponding to the comment, and display the barrage data on the live broadcast page.

In an embodiment, the apparatus further includes a media switching module. The media switching module is configured to: change, in real time according to a scene switchover in the interaction, a media identifier corresponding to the live broadcast page, and switch, by using the media identifier, to a scene sound effect suitable for a scene in the interaction.

In an embodiment, a network application display control apparatus is further provided, and is applied to a user terminal. As shown in FIG. 21, the apparatus includes a network application running module 810, a control processing module 830, and a control response module 850.

The network application running module 810 is configured to: trigger, by using a live broadcast page for interaction in a network application displayed by a display terminal in an interactive live broadcast site, running of the network application, and enter the interaction that is broadcast live.

The control processing module 830 is configured to: listen to a control instruction for the network application that is triggered for the live broadcast page displayed in the display terminal, and initiate a control request to a server end according to the control instruction.

The control response module 850 is configured to: in response to the control request, update, in real time by using a persistent connection established to the server end, a page in the network application run on the user terminal.

Further, in this embodiment, as shown in FIG. 22, the network application running module 810 includes a live broadcast page response unit 811, a user authorization unit 813, and a join initiation unit 815.

The live broadcast page response unit 811 is configured to: trigger, by using the live broadcast page displayed in the display terminal, running of the network application in the interactive live broadcast in the network application that is triggered in the interactive live broadcast site.

The user authorization unit 813 is configured to authorize a user that logs in to another application run in the user terminal as a user of the network application.

The join initiation unit 815 is configured to: initiate a join request for the interaction in the network application, and in response to the join request, join the interaction.

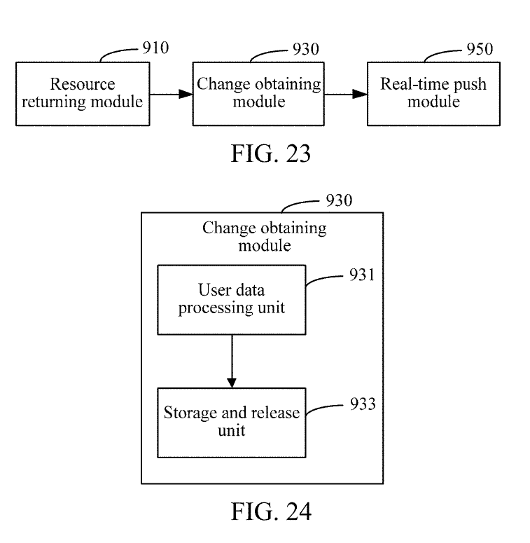

In an embodiment, a real-time update apparatus during network application display is further provided, and is applied to a server end. As shown in FIG. 23, the apparatus includes a resource returning module 910, a change obtaining module 930, and a real-time push module 950.

The resource returning module 910 is configured to: in response to an interactive live broadcast initiated by a display terminal for a network application, return a network application resource to the display terminal, the network application resource enabling the display terminal to enter the interactive live broadcast in the network application.

The change obtaining module 930 is configured to: obtain a dynamic change in user data that is in the network application and that conforms to specified content for release, and generate an update message corresponding to the dynamic change.

The real-time push module 950 is configured to push an update message corresponding to the dynamic change to the display terminal in real time by using a persistent connection established to the display terminal.

Further, in this embodiment, as shown in FIG. 24, the change obtaining module 930 includes a user data processing unit 931 and a storage and release unit 933.

The user data processing unit 931 is configured to: process, in the interactive live broadcast according to the specified content for release, the user data in the interaction in the network application, to obtain live information conforming to the specified content for release, and obtain, from the live information, the dynamic change related to the specified content for release.

The storage and release unit 933 is configured to: store the dynamic change related to the specified content for release, and release, by using a preset subscription and release function, the update message corresponding to the dynamic change.

In an embodiment, the real-time push module is further configured to distribute the released update message to the persistent connection corresponding to the interactive live broadcast, to push the update message in real time by using the persistent connection.

A person of ordinary skill in the art may understand that all or some of the steps of the foregoing embodiments may be implemented by using hardware, or may be implemented by a program instructing relevant hardware. The program may be stored in a computer-readable storage medium. The storage medium may be a read-only memory, a magnetic disk, an optical disc, or the like.

Although the present disclosure is described by referring to several typical implementations, it should be understood that, the used terms are illustrative and exemplary rather than limitative terms. Because the present disclosure can be specifically implemented in multiple forms without departing from the spirit or essence of the present disclosure, it should be understood that, the foregoing implementations are not limited to any foregoing details, and should be widely explained within the spirit and scope limited by the appended claims. Therefore, all changes and variations that fall within the claims or an equivalent scope thereof shall be covered by the appended claims.

What is claimed is:

1. A method, comprising:
at a computing device having one or more processors and memory, wherein the computing device is configured to control display of a live broadcast of an interactive multi-user activity session in a network application:
receiving a user request for triggering an interactive live broadcast in the network application;
in response to receiving the user request, obtaining from a server end and causing display on a display located at a public broadcast location of a live broadcast page for interaction in the network application, the interaction in the network application is to be performed among users corresponding to user terminals that are located in proximity to the public broadcast location;
obtaining, in real time by using a persistent connection established to the server end, an update message that is pushed by the server end according to specified content for release in the live broadcast page, the update message corresponding to a dynamic change in user data in the interaction in the network application that is performed among the users corresponding to the user terminals that are located in proximity to the public broadcast location; and
updating display of the live broadcast page in real time according to the update message.

2. The method according to claim 1, wherein the method further comprises:
displaying, on the live broadcast page, access information that is generated according to the network application, wherein the access information enables a user terminal to access an interactive live broadcast site to download or access the network application and to join the interaction in the network application.

3. The method according to claim 1, wherein the step of in response to receiving the user request for triggering an interactive live broadcast in the network application, obtaining from a server end a live broadcast page for interaction in the network application, comprises:
initiating a network application resource request to the server end;
receiving a network application resource that is returned by the server end in response to the resource request; and
obtaining the live broadcast page in the display terminal by loading the network application resource.

4. The method according to claim 3, wherein the specified content for release in the live broadcast page comprises an identifier of a user joining the interaction, and the step of obtaining, in real time by using a persistent connection established to the server end, an update message that is pushed by the server end according to specified content for release comprises:
in response to a join request or an exit request initiated by a respective user terminal in the interaction in the network application for the live broadcast page, obtaining, in real time by using the persistent connection established to the server end, an update message that is pushed by the server end according to a change in a user count in the interaction.

5. The method according to claim 4, wherein the step of updating the display of the live broadcast page in real time according to the update message comprises:
obtaining, from the update message, the change in the user quantity in the interaction, and updating, in real time according to the change in the user quantity, the identifier of the user displayed on the live broadcast page.

6. The method according to claim 1, wherein the specified content for release comprises a ranking of the user in the interaction, and the step of updating the user data on the live broadcast page in real time according to the update message comprises:
obtaining, from the update message, the ranking of the users in the interaction, and updating ranking data of the users on the live broadcast page in real time.

7. The method according to claim 1, wherein the specified content for release comprises a comment made on the interaction, and the step of updating the user data on the live broadcast page in real time according to the update message comprises:
obtaining, from the update message, respective comments made by one or more of the users on the interactive live broadcast;
generating barrage data corresponding to the respective comments; and
displaying the barrage data on the live broadcast page.

8. A computing device, comprising:
one or more processors;
memory; and
a plurality of instructions stored in the memory that, when executed by the one or more processors, cause the one or more processors to perform operations, wherein the computing device is configured to control display of a live broadcast of an interactive multi-user activity session in a network application, and wherein the operations include:
receiving a user request for triggering an interactive live broadcast in the network application;
in response to receiving the user request, obtaining from a server end and causing display on a display located at a public broadcast location of a live broadcast page for interaction in the network application, the interaction in the network application is to be performed among users corresponding to user terminals that are located in proximity to the public broadcast location;
obtaining, in real time by using a persistent connection established to the server end, an update message that is pushed by the server end according to specified content for release in the live broadcast page, the update message corresponding to a dynamic change in user data in the interaction in the network application that is performed among the users corresponding to the user terminals that are located in proximity to the public broadcast location; and
updating display of the live broadcast page in real time according to the update message.

9. The computing device according to claim 8, wherein the operations further include:
displaying, on the live broadcast page, access information that is generated according to the network application, wherein the access information enables a user terminal to access an interactive live broadcast site to download or access the network application and to join the interaction in the network application.

10. The computing device according to claim 8, wherein the step of in response to receiving the user request for triggering an interactive live broadcast in the network application, obtaining from a server end a live broadcast page for interaction in the network application, includes:
initiating a network application resource request to the server end;
receiving a network application resource that is returned by the server end in response to the resource request; and
obtaining the live broadcast page in the display terminal by loading the network application resource.

11. The computing device according to claim 10, wherein the specified content for release in the live broadcast page comprises an identifier of a user joining the interaction, and the step of obtaining, in real time by using a persistent connection established to the server end, an update message that is pushed by the server end according to specified content for release comprises:
in response to a join request or an exit request initiated by a respective user terminal in the interaction in the network application (e.g., a user's request to join or exit the multi-user activity session that are received from a respective user terminal through the interactive live broadcast site or through the downloaded network application) for the live broadcast page, obtaining, in real time by using the persistent connection established to the server end, an update message that is pushed by the server end according to a change in a user count in the interaction.

12. The computing device according to claim 11, wherein the step of updating the display of the live broadcast page in real time according to the update message comprises:
obtaining, from the update message, the change in the user quantity in the interaction, and updating, in real time according to the change in the user quantity, the identifier of the user displayed on the live broadcast page.

13. The computing device according to claim 8, wherein the specified content for release comprises a ranking of the user in the interaction, and the step of updating the user data on the live broadcast page in real time according to the update message comprises:
obtaining, from the update message, the ranking of the users in the interaction, and
updating ranking data of the users on the live broadcast page in real time.

14. The computing device according to claim 8, wherein the specified content for release comprises a comment made on the interaction, and the step of updating the user data on the live broadcast page in real time according to the update message comprises:
obtaining, from the update message, respective comments made by one or more of the users on the interactive live broadcast;
generating barrage data corresponding to the respective comments; and
displaying the barrage data on the live broadcast page.

15. A non-transitory computer-readable storage medium storing a plurality of instructions configured for execution by a computing device having one or more processors, wherein the computing device is configured to control display of a live broadcast of an interactive multi-user activity session in a network application, and wherein the plurality of instructions cause the computing device to perform the following operations:
receiving a user request for triggering an interactive live broadcast in the network application;
in response to receiving the user request, obtaining from a server end and causing display on a display located at a public broadcast location of a live broadcast page for interaction in the network application, the interaction in the network application is to be performed among users corresponding to user terminals that are located in proximity to the public broadcast location;
obtaining, in real time by using a persistent connection established to the server end, an update message that is pushed by the server end according to specified content for release in the live broadcast page, the update message corresponding to a dynamic change in user data in the interaction in the network application that is performed among the users corresponding to the user terminals that are located in proximity to the public broadcast location; and
updating display of the live broadcast page in real time according to the update message.

16. The non-transitory computer-readable medium according to claim 15, wherein the operations further include:
displaying, on the live broadcast page, access information that is generated according to the network application, wherein the access information enables a user terminal to access an interactive live broadcast site to download or access the network application and to join the interaction in the network application.

17. The non-transitory computer-readable medium according to claim 15, wherein the step of in response to receiving the user request for triggering an interactive live broadcast in the network application, obtaining from a server end a live broadcast page for interaction in the network application, includes:
initiating a network application resource request to the server end;
receiving a network application resource that is returned by the server end in response to the resource request; and
obtaining the live broadcast page in the display terminal by loading the network application resource.

18. The non-transitory computer-readable storage medium according to claim 17, wherein the specified content for release in the live broadcast page comprises an identifier of a user joining the interaction, and the step of obtaining, in real time by using a persistent connection established to the server end, an update message that is pushed by the server end according to specified content for release comprises:
in response to a join request or an exit request initiated by a respective user terminal in the interaction in the network application (e.g., a user's request to join or exit the multi-user activity session that are received from a respective user terminal through the interactive live broadcast site or through the downloaded network application) for the live broadcast page, obtaining, in real time by using the persistent connection established to the server end, an update message that is pushed by the server end according to a change in a user count in the interaction.

19. The non-transitory computer-readable storage medium according to claim 18, wherein the step of updating the display of the live broadcast page in real time according to the update message comprises:
obtaining, from the update message, the change in the user quantity in the interaction, and updating, in real time according to the change in the user quantity, the identifier of the user displayed on the live broadcast page.

20. The non-transitory computer-readable storage medium according to claim 15, wherein the specified content for release comprises a ranking of the user in the interaction, and the step of updating the user data on the live broadcast page in real time according to the update message comprises:
obtaining, from the update message, the ranking of the users in the interaction, and
updating ranking data of the users on the live broadcast page in real time.
